(19) United States
(12) Patent Application Publication
(10) Pub. No.: US 2008/0106140 A1
(43) Pub. Date: May 8, 2008

(54) Display Apparatus For Wheel Hub

(76) Inventor: Andres Velez, Sunland, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/935,973

(22) Filed: Nov. 6, 2007

Related U.S. Application Data
(60) Provisional application No. 60/864,439, filed on Nov. 6, 2006.

(51) Int. Cl. B60B 7/14

(52) U.S. Cl. 301/37.102

(57) ABSTRACT

A display apparatus for an automobile wheel is disclosed The display apparatus may comprise a faceplate removably coupled to a counterweight. The counterweight may be coupled to an adapter assembly including an adapter, a bearing device, a bushing and a coupler. The coupler may have a plurality of prongs. The coupler of the display apparatus nay be designed so that is may be pushed into a hub of a rim of an automobile wheel of attachment. The counterweight may comprise a foot portion that is sufficiently heavy to keep the faceplate relatively stationary about an axis of rotation of the wheel when the automobile is in motion.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This application claims the benefit of Provisional Patent Application Ser. No. 60/864,439 filed Nov. 6, 2006, which is incorporated herein by reference.

### BACKGROUND

1. Field

This disclosure relates to wheel coverings and wheel display devices, including but not limited to automobile wheels.

2. Description of the Related Art

Wheel rims, hub caps, and center caps of various types provide protection to automobile wheels and adornment for an automobile wheel. Manufacturers provide wheel rims and center caps that enhance the style of a vehicle and may advertise the brand of car. Car owners may have a desire to publicize their own interests, advertise products, promote stores, show off their affiliation with a sports or religious organization, and otherwise make a statement. A hub mountable display apparatus with easily removable faceplates that remains relatively level and stationary while a wheel and vehicle is in motion provides this ability to car owners.

### DESCRIPTION OF THE DRAWINGS

FIG. 1 is an illustration of an automobile and a display apparatus.

FIG. 2 is an exploded side view of a display apparatus.

FIGS. 3A, 3B and 3C are inner, side and outer views of a coupler.

FIGS. 4A and 4B are a side view and plan view of a bushing.

FIGS. 5A, 5B and 5C are side, inner and outer views of an adapter.

FIGS. 6A and 6B are a side view and plan view a first embodiment of a counterweight.

FIGS. 7A and 7B are a side view and plan view a second embodiment of a counterweight.

FIGS. 8A and 8B are a side and a plan view of a faceplate.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

This disclosure is directed to a device to add stylistic customization to automotive wheels. A display apparatus for attachment to a hub recess of an automotive or other wheel is described herein. More specifically, the display apparatus includes an interchangeable faceplate that remains relatively level, stable, and not rotating while the automotive wheels rotate. The faceplate may include an artistic design. Because the faceplate does not rotate while a wheel and the vehicle to which it is attached is in motion, a person will be able to view and appreciate the decorative faceplate of the assembly while the automobile passes by. Moreover, the display apparatus is easy to attached to the hub of an automobile wheel rim and may be customized by the vehicle owner by the easy removal and replacement of faceplates.

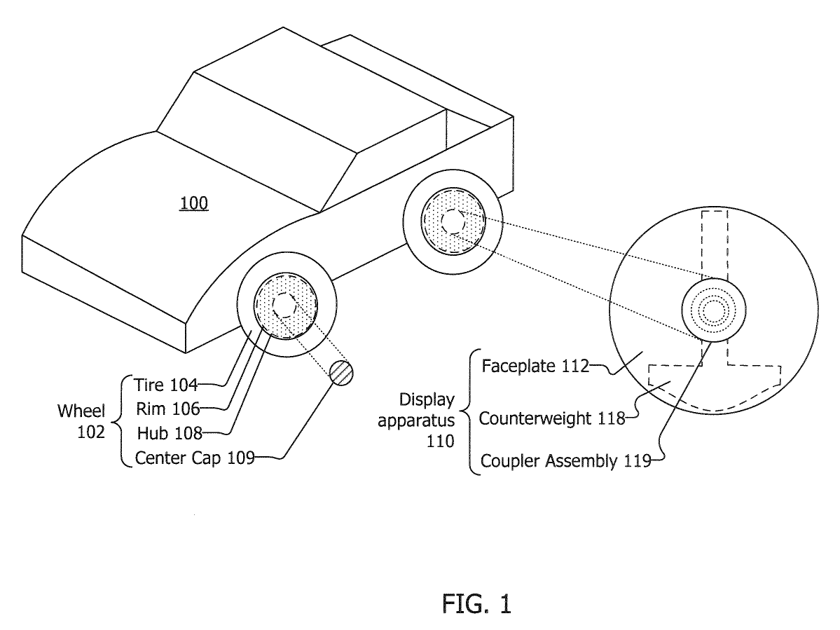

Referring now to FIG. 1, there is shown a drawing of an automobile and the display apparatus for wheel hub described herein. Automobile 100 is a typical automobile having four wheels 102. The wheel 102 includes a tire 104 and a rim 106. The rim 106 is attached to an automobile's axel using lug nuts (not shown). The lug nuts may be hidden behind a center cap 109 or hub cap placed in or attached to the hub 108 of the rim 106, or may be visible as part of the rim 106. The center cap 109 and wheel rim 108 are included by automobile manufacturers with the automobile upon initial sale of the automobile. Some consumers buy aftermarket replacement decorative rims and/or center caps to replace those provided as original equipment by the manufacturer.

As described herein, the center cap 109 is replaced with the display apparatus 110. Unlike earlier devices, the display apparatus 110 is not coupled to the wheel with the wheel's lug nuts. The display apparatus 110 has no physical relationship whatsoever with the lug nuts of the wheel 102. After a center cap 109 is removed from the hub 108 of the rim 106, the display apparatus 110 may be placed or pushed into the hub 108. This may be achieved using the force of a person's hand. In some instances a rubber mallet may or other device be used to assist in placing the display apparatus 110 into the hub 108 of the rim 106.

As shown in FIG. 1, the display apparatus 110 includes a faceplate 112, a counterweight 114, and a coupler assembly 119. The coupler assembly 119 may include an adapter 116, a ball bearing device 120, a bushing 122, and a coupler 118, and may also include a washer 124, all of which are described in more detail below. The coupler assembly 119 includes a coupler 118 (described in more detail below) constructed to be of a size that fits into typical wheel rim hubs. The coupler 118 may be constructed to be of a size that fits into the more popular sized wheel rim hubs. Because there are various dimensions for automotive wheels and hubs, the dimensions of the display apparatus 110 and including the coupler 118 and the faceplate 112 may be tailored for different automobile hub and rim sizes. The details of the constituent parts of the display apparatus 110 are described in more detail below.

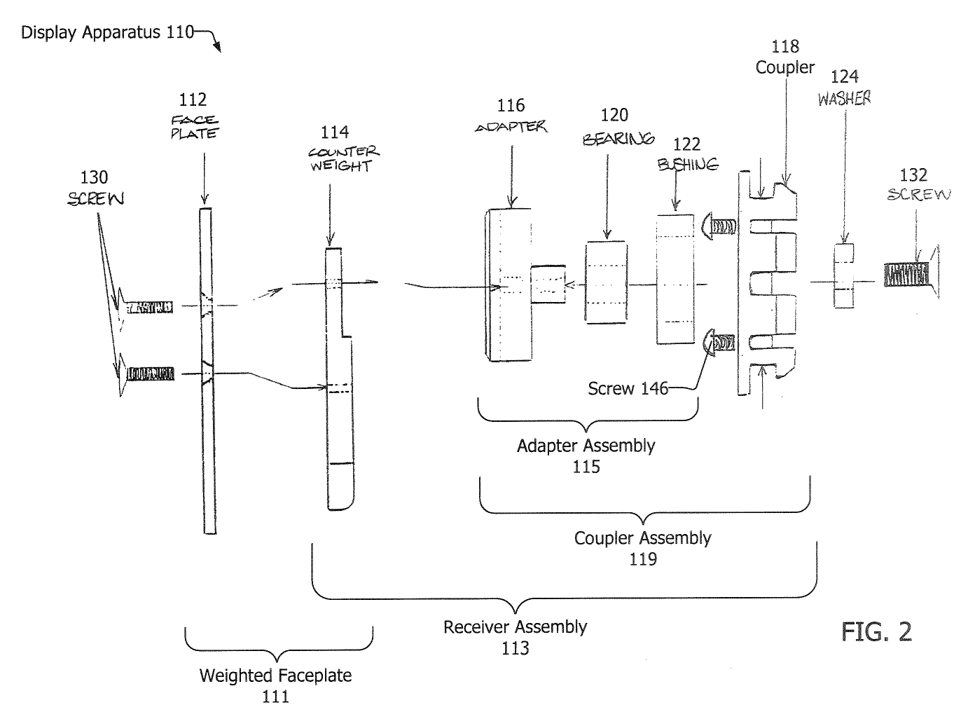

Referring now to FIG. 2, there is shown an exploded side view of the display apparatus 110. The display apparatus 110 is a mechanical device which attaches to an automotive wheel proximate to the hub recess. The display apparatus 110 provides a faceplate 112 having a surface which does not rotate when the automotive wheels rotate.

In one embodiment, the display apparatus 110 includes the following components: a faceplate 112, counterweight 114, a ball bearing device 120, an adapter 116 designed to both fit to an inner surface of the ball bearing device 120 and provide a mounting surface for the counterweight 114, a coupler 118, and a bushing 122 disposed between an outer surface of the ball bearing 120 and the coupler 118, wherein the ball bearing device 120 fits within the bushing 122 and the bushing fits within the coupler 118. More specifically, the ball bearing 120 may be press fit within the bushing 122. The bushing 122 may be press fit within the coupler 118.

The combination of the adapter 116, ball bearing device 120, and bushing 122 may be referred to as the adapter assembly 115. In this embodiment, the coupler 118 may be attached to the adapter assembly 115 by screw 132 or other fastener, by pressure fit, and/or by other techniques.

The combination of the counterweight 114, the adapter assembly 115, and the coupler 118 may be referred to as a receiver assembly 113.

One or more fasteners secure the faceplate 112 to the counterweight 114. In one embodiment, the faceplate 112 may be removably attached to the counterweight 114 to allow for easy replacement of the faceplate 112 after the receiver assembly 113 is attached to a wheel rim hub 108. In one embodiment, the fastener is a screw 130, such as an allen flat head screw. In one embodiment, two screws are used to attach the faceplate 118 to the counterweight 114, and the back and front of the faceplate are completely flat. In another embodiment, a first screw is used to couple the faceplate to the counterweight and a second screw is used to couple the faceplate 112 to the adapter 116 through the counterweight 114. Other embodiments are also described below. Other kinds of screws and other hardware may be used to secure faceplate 112 to the counterweight and the counterweight 114 to the adapter 116.

Fasteners are mechanical devices which secure one member to another. The term fasteners as used herein refers to screws, rivets, bolts, pins, washers and other hardware. Although fasteners are disclosed for attaching the components listed above, adhesives, friction, and magnets may be utilized in conjunction with or in substitution for the fasteners. To illustrate attachment via friction, the ball bearing may fit within the bushing and the coupler. More specifically, the fit may be a friction fit or an interference fit.

An example of an interference fit is where the outer surface of the bearing is forced into the inner diameter of the bushing, the surface defining the inner diameter of the bushing is deformed to a larger dimension while the surface defining the inner diameter of the bushing applies a compressive force against the outer surface of the bearing, resulting in friction between the bearing and the bushing. Interference fits are characterized by a diametral interference of approximately 0.001 to 0.002 units per unit of shaft diameter. Additionally, a friction fit is characterized by diametral interference of less than approximately 0.001 to 0.002 units per unit of shaft diameter. Because of friction, neither attachment by friction fit nor interference fit requires fasteners.

In one embodiment, as shown in FIG. 2, the fastener which attaches the faceplate to both the counterweight and the adapter is a 6/32″ allen flat head machine screw. Thus, the faceplate, the counterweight and the adapter include threads for receiving the machine screw. Additionally, the faceplate 112 may be adapted to provide for countersinking of a screw head, thereby enhancing the aesthetic features of the faceplate 112.

As shown in FIG. 2, the adapter 116 may be coupled to the coupler 118 using a fastener such as, for example, an 8/32″ allen flat head machine screw 132 and a washer 124. The adapter 116 includes threads for receiving the screw 132.

In one embodiment, the adapter 116, ball bearing device 120, and bushing 122 may be pre-assembled as a single unit referred to as the adapter assembly 115. In this embodiment, the coupler 118 may be attached to the adapter assembly 115

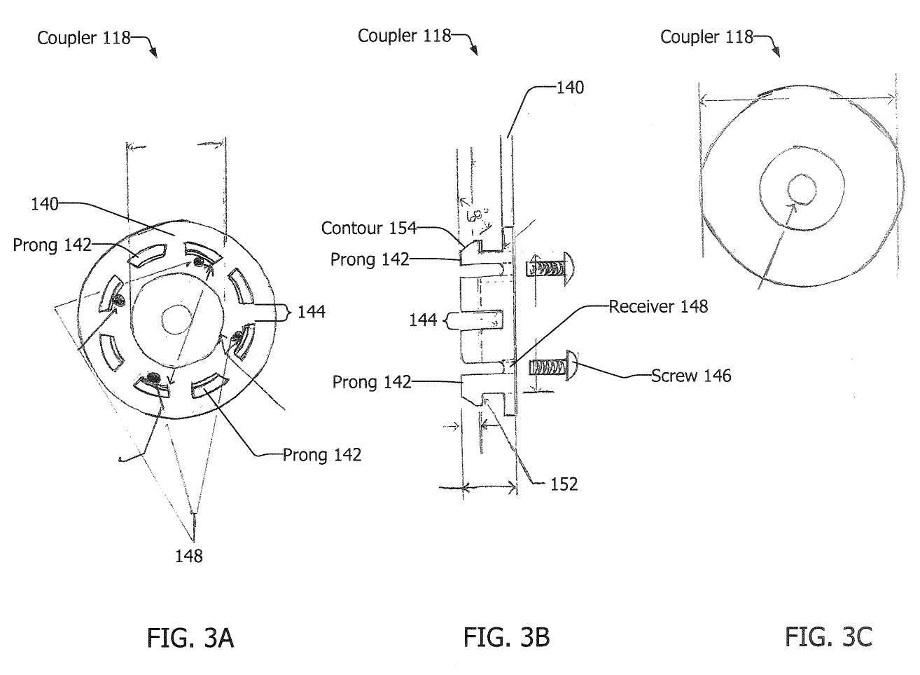

Referring now to FIGS. 3A, 3B and 3C, there are shown inner, side and outer views of the coupler 118. As used herein, the term inner refers to the side facing the automobile, and the term outer means the side away from the automobile. In one embodiment, the coupler 118 is manufactured from plastic. In other embodiments, the coupler may be manufactured from metals, composites, plastics and/or combinations of these materials. Further, the coupler may be injection molded plastic, machined aluminum, or other strong resilient material that can be shaped accordingly.

The coupler 118 is a device having protrusions or prongs 142 and a body 140. A prong 142 is a portion of the body 140 which sticks out generally perpendicularly from a main portion of the body 140. In various embodiments, there may be 3, 4, 6, 7, 8, 10 prongs 142. There are eight prongs shown in exemplar coupler 118 shown in FIG. 3. The prongs 142 may be adapted to deform radially inward towards the center of the coupler 118 when pressed into the center of an automotive wheel rim hub 108. Moreover, the prongs 142 may be adapted to mount the display apparatus 110 to the center of the wheel at the hub 108.

The prongs 142 may have a length that is selected to have as much surface contact with the inner portion of the hub 108 and not interfere with the functioning of an automobile. In turn, the prongs 142, when inserted into the center of a wheel, may form a press fit, a friction fit, or an interference fit with the wheel. The type of fit may be selected by the weight of the center hub assembly, the materials of the coupler and the wheels, and other factors.

In one embodiment, the prongs 142 extend approximately ⅜″ from the flat body portion 140 of the coupler 118. In one embodiment, the prongs 142 are approximately ½″ long. In one embodiment, the prongs 142 are spaced about ¼″ apart as shown by gap 144. These measurements are only examples. In various embodiments, more and fewer, larger and smaller prongs 142 and gaps 144 may be used.

In one embodiment, the prongs 142 include lips 152 (which may be contoured) on the outer side, the side that will be in contact with the hub 108. The prongs 142 may have a lip 152 or overhang and be contoured externally at an angle such as, for example 60 degrees. The contour may assist a user in the attaching of the coupler to the hub of a rim. The lip 152 or overhang may be designed to be complementary to a ridge on the hub of a rim to assist with the attaching of the coupler to the hub of the rim.

In one embodiment, set screws 146 may be included in screw receiving areas 148 adjacent to or abutting two or more prongs 142. In this embodiment, after the display apparatus 118 is placed in a hub 108, the set screws may be tightened, exerting force against the prongs 142 and moving prongs 142 outward from the center of the coupler 118 toward the edge of the hub 108, thus increasing the press fit of the coupler 118 into the hub 108. In this way the set screws may be used to increase the durability and strength of the coupling of the display apparatus 110 to the hub 108 via the coupler 118.

In other embodiments, the coupler 118 may be used to mount the display apparatus 118 to the hub 108 via fasteners, adhesives, magnets or combinations thereof.

In one embodiment, the coupler 118 has a single circumferential ring (not shown) having a contour 154 and resulting lip 152, circumferential ring extending from the main portion of the body 140 of the coupler 118. The circumferential ring is effectively like prongs 142 without the gaps 144 between the prongs, or the gaps 144 being filled. In this embodiment, set screws 146 may be used to enhance a press fit of the circumferential ring of the coupler 118 to the hub.

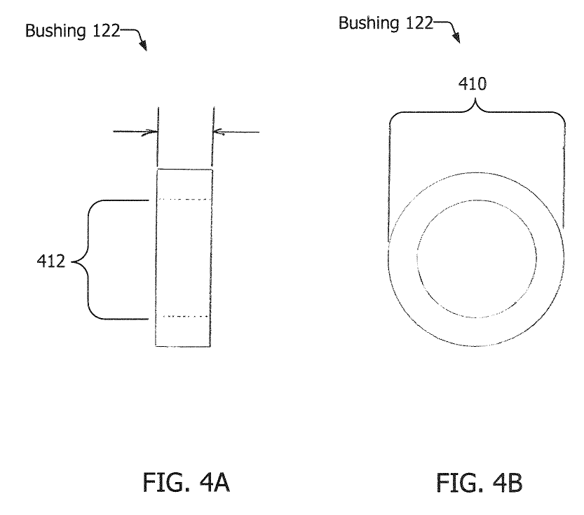

Referring now to FIGS. 4A and 4B, there is shown a side view and plan view of a bushing 122. A bushing is a removable lining or sleeve of metal or other material that is inserted or screwed into an opening to limit its size, resist wear or erosion, or serve as a guide. In one embodiment, display apparatus 110 includes a bushing that is press fit into the body of the coupler 118. In other embodiments, the bushing 122 may be omitted if the dimensions of an opening within the coupler are commensurate with the outer surface of the ball bearing device 120.

The outer diameter 410 of the bushing may fit an inner diameter of an opening defined by the body of the coupler 118. The inner diameter 412 of the bushing 122 may fit an outer diameter of the outer surface of the ball bearing 120. The bushing may provide dampening between the coupler 118 and the ball bearing 120. Dampening refers to an effect that diminishes or reduces the amplitude or intensity of vibration or shock over a period of time. Dampening is typically the result of viscosity or friction. However, dampening may result from elastic deformation of a solid. Additionally, dampening may result from a conversion of kinetic or potential energy to internal energy, heat energy, or even a chemical reaction.

Since the coupler 118 is adapted for mounting to the automotive wheel, when the automobile is moving, shock and vibration necessarily will be transferred from the wheel to the coupler. Because the bushing may serve as a dampener within the center hub assembly, the ball bearing, adapter, counterweight and faceplate may be at least partially isolated from the shock and vibration from the wheel. As a result, the life cycle of the ball bearing, adapter, counterweight and faceplate may be maximized.

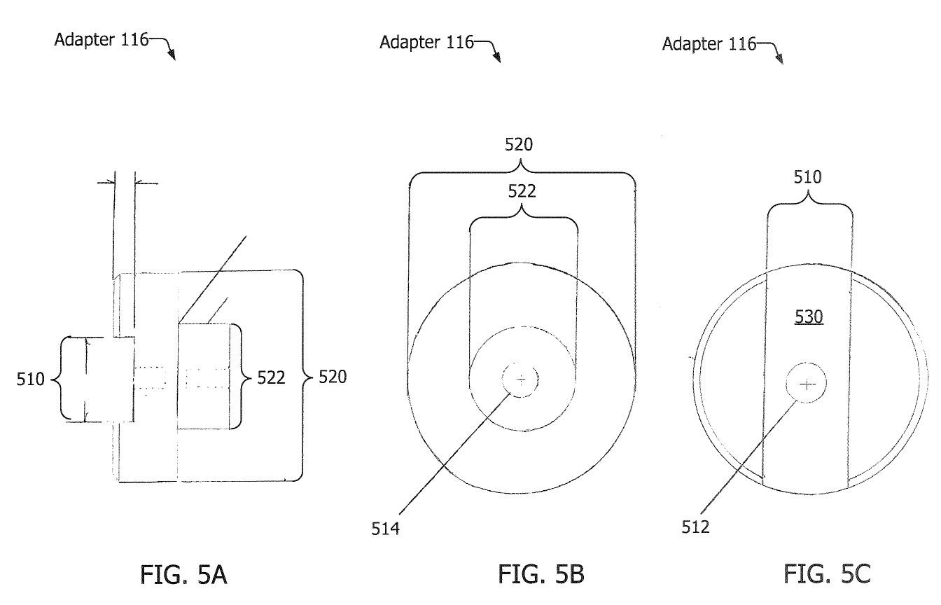

Referring now to FIGS. 5A, 5B and 5C, there is shown side view, an inner view and an outer view, respectively, of an adapter 116. An adapter 116 is a device for mounting multiple components together. In one embodiment, the adapter is aluminum. In other embodiments, the adapter 116 may be manufactured from a variety of relatively strong, resilient materials. The adapter 116 may be a separate component (as shown) or may be integral to the counterweight 114.

As shown, the adapter 116 may include two sections. One section, the inner section shown in FIG. 5B, may be adapted to fit with or mount to an inner diameter of the inner surface of the ball bearing device 120. More specifically, the adapter 116 may be press fit into the ball bearing device 120. The other or outer section of the adapter 116 may be adapted to mate with the counterweight 114, as shown in FIG. 5C. Additionally, the adapter may include a surface 530 that the counterweight 114 firmly abuts. Moreover, the surface may be perpendicular to the axis of rotation of the adapter 116 (and of the wheel 102). When the counterweight 114 is secured to the adapter 116, the counterweight is unlikely to rotate in an axis other than the same axis in which the wheel rotates. In simple terms, the counterweight is unlikely to wobble.

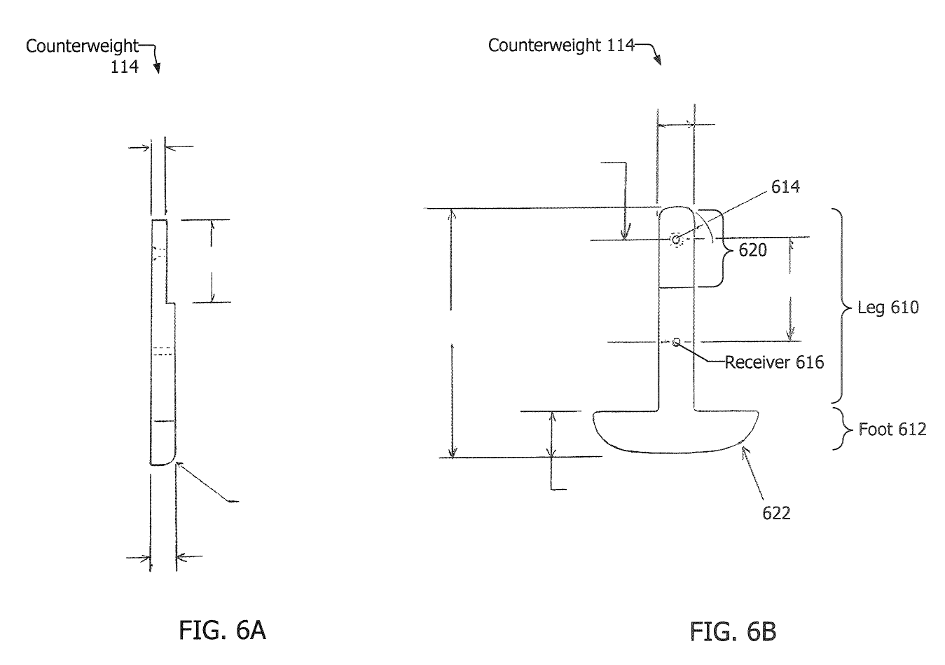

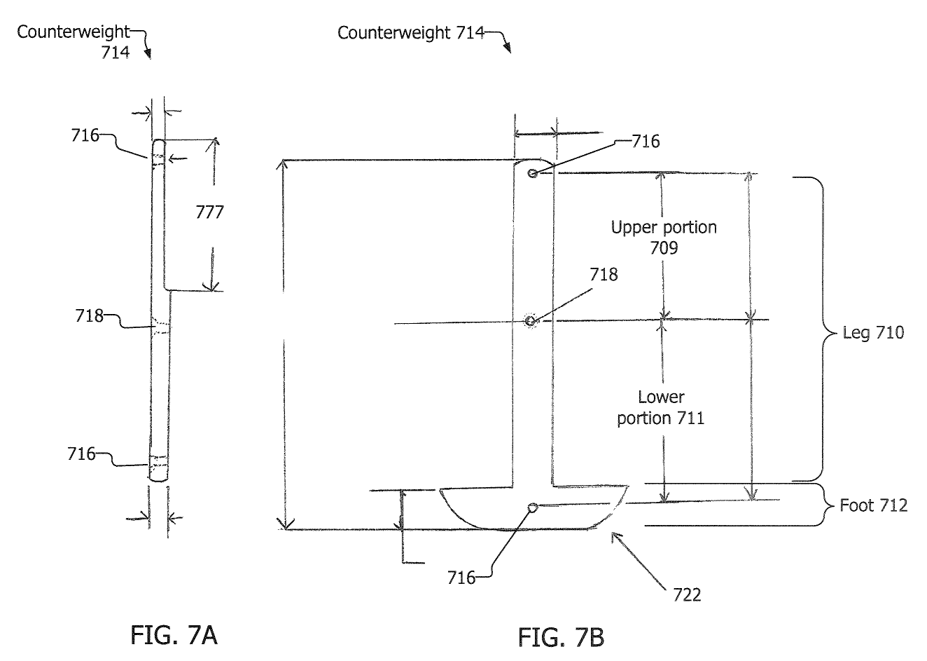

Referring now to FIGS. 6A, 6B, 7A and 7B, there is shown a side view and plan view of two embodiments of a counterweight 114 and 714. The counterweights 114 and 714 are constructed such that gravity causes the counterweight to remain below a pivot or axis of rotation of the tire 104. The counterweights 114 and 714 may be constructed to generally be the shape of the letter “T”. In practice, the letter “T” is upside down when the display apparatus is attached to a wheel. The counterweights 114 and 714 may be constructed to be the shape of an umbrella or mushroom. In practice, the umbrella or mushroom is upside down when the display apparatus is attached to a wheel. Based on their shape and configuration, the counterweights 114 and 714 have a center of gravity that is radially asymmetric to an axis through which the counterweight 114/714 is mounted to the adapter 116. The foot 612/714 of the counterweights 114/714 are weighted to as to keep the display apparatus 110 and, in particular the faceplate 112 and the message, graphic, or advertisement level and relatively stationary while the wheel is rotating and the automobile is in motion. The foot 612/714 may be a relatively heavy substance such as metal. The foot may be relatively heavy merely by virtue of its comparative size in view of the shape and size of the leg 610/710. Stated another way, the foot 612/714 of the counterweight 114/714 is weighted to as to keep the leg 610/710 generally perpendicular to the direction the automobile is travelling while the automobile is in motion, and to keep the leg 610/710 generally perpendicular to the ground and stationary when the vehicle is stationary. The counterweight 114/714 may be an independent component or integral with one or more of the adapter 116 and the faceplate 112.

Referring now to FIGS. 6A and 6B, in one embodiment, the counterweight 114 is attached to the adapter 116 via hole 614 of a size to receive a screw 130. Other fasteners may also be used as described above. Because counterweight 114 is attached to the adapter 116 with the center of gravity offset from the rotating axis of the ball bearing 120, the foot 612 of the counterweight 114 (and the adapter 116) remains below the rotating axis of the ball bearing device 120 and remains generally level and stationary while an automobile is in motion.

The counterweight 114 may include a mounting surface 620 to which the faceplate 112 may be attached. The faceplate 114 may be attached to the counterweight 114 by two screw. In one embodiment, a first screw may pass through the faceplate 114 and hole 614 of the counterweight and couple with a receiver in adapter 116. In this embodiment, a second screw may pass through the faceplate 112 and couple with receiver 616 in counterweight 114. The mounting surface 620 may be disposed vertically. The foot 612 of the counterweight 114 may be contoured to as to conform to the curve of the outer edge or circumference of the faceplate 112 as shown by contour 622.

The angle of incline of the mounting surface may be selected such that when the faceplate is attached to the mounting surface, the faceplate is easily viewed from a person sitting in an adjacent vehicle or on the side of a road.

Referring now to FIGS. 7A and 7B, a side view and plan view of another embodiment of a counterweight 714 is shown. In this example, the full length of the counterweight 714, including the leg 710 and the foot 712, is approximately the same as the diameter of a faceplate which will attach to the counterweight 714 using receivers 716. The foot 712 of the counterweight 714 may be contoured to as to conform to the curve of the outer edge or circumference of the faceplate 112 as shown by contour 722. The counterweight 714 may be coupled with the adapter 116 through hole 718. In this embodiment, an area occupying substantially the area the between hole 718 or the midpoint of leg 710 on one end and the end of leg 710 opposite foot 712 is thinner or otherwise includes less material so as to be much lighter than the portion of the leg 710 between the midpoint of leg 710 and the foot 712. As shown in FIG. 7B, upper portion 709 is lighter than lower portion 711, upper portion 709 contains less material than lower portion 711, and/or upper portion 709 is sculpted when compared to portion 711 as shown by the area 777 in FIG. 7A. That is, area 777 is in upper portion 709 and predominates the upper portion 709.

Because counterweight 714 is attached to the adapter 116 with the center of gravity offset from the rotating axis of the ball bearing 120, the foot 712 of the counterweight 714 remains below the rotating axis of the ball bearing device 120 and remains generally level and stationary while an automobile is in motion.

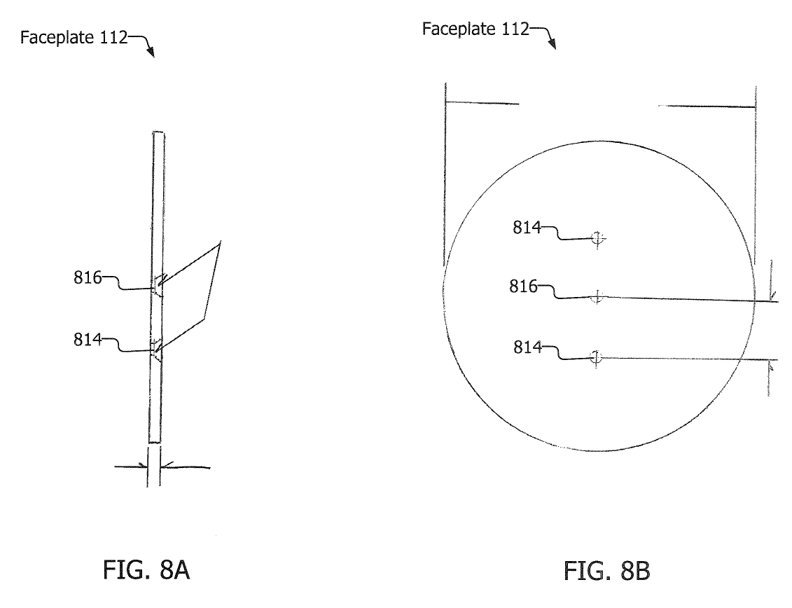

Referring now to FIGS. 8A and 8B, there is shown a side and a plan view of a faceplate 112. The faceplate 112 may be manufactured from any relatively strong resilient materials including plastics, metals, resins, and combinations of these. In one embodiment, the faceplate 112 is aluminum. In another embodiment, the faceplate 112 is plastic. The faceplate 112 may mount to the counterweight 114. The faceplate may be removable from the counterweight 114 and 714. In one embodiment, the faceplate 112 may mount directly (in whole or in part) to the adapter 116 through the faceplate 114 or 714. In various embodiments, the faceplate 112 may be integral to the counterweight 114/714 and the adapter 116, or the faceplate 112 may be integral to the counterweight 114/714 and the adapter 116 such that they form a single sub-assembly.

In one embodiment the faceplate 112 may be attached to the counterweight 714 via two screws through outer holes 814, and the counterweight 114 is coupled to the adapter 116 with a single screw prior to the faceplate 112 being attached to counterweight 714. In this example, the faceplate may have two holes 814 and no hole 816.

In another embodiment the faceplate 112 may be attached to the counterweight 714 via two screws through outer holes 814, and the faceplate 112 may be coupled through the counterweight 714 to the adapter 116 with a single screw through hole 816. In this example, the faceplate may have two holes 814 and a center hole 816.

In another embodiment the faceplate 112 may be attached to the counterweight 114 via one screw through one outer hole 814, and the faceplate 112 may be coupled through the counterweight 114/714 to the adapter 116 with a single screw through center hole 816. In this example, the faceplate may have one hole 814 and a center hole 816.

The faceplate 112 may have a geometry of a disk having a radius that is based upon the radius of the opening of the hub 108. The faceplate 112 may have a geometry of a disk having a diameter generally equal to the diameter of the opening of the hub 108. Similarly, in another embodiment, the faceplate 112 covers both the hub and the lug nut area of the rim, a recessed portion of the rim. This is shown in FIG. 1. The faceplate 112 may have a geometry of a disk having a diameter generally equal to the diameter of the rim 106. If the geometry of the disk is commensurate with that of the wheel opening about the hub 108 or rim 106, then the faceplate 112 will appear flush with the wheel 102. In this way the faceplate 112 may appear to be part of the wheel 102 and flush with the wheel 102. In some embodiments, the faceplate 112 may cover the entire diameter of the rim 102. In one embodiment, the faceplate 112 can be manufactured to appear to be part of the wheel 102 so the faceplate 112 (and the display apparatus 110 as a whole) is aesthetically pleasing as it does not stick out or otherwise extend from the wheel 102. That is, the faceplate 112 is flush and/or is even with the plane formed by the sidewall of the tire 104.

The faceplate 112 may provide a surface for artistic expression, affiliation, membership, community, advertisement or general communications in the form of text and/or graphics or other representation. Examples of artistic expression include photographs of nature and/or people. Examples of advertisements include slogans, logos, brand names, and sketches of goods. Examples of general communications include political rhetoric and religious speech, depicted textually and/or graphically. Examples of affiliation, membership, and community include school names, logos and mascots; sports teams names, mascots and logos; town names and icons; church names and icons; and many others.

Because the faceplate is removable, multiple faceplates many be created that can easily be swapped, enabling a purchaser to display one given faceplate within a given community at a particular time and alternative faceplates in other situations. The display apparatus provides a simple, non-obtrusive device that allows a person to customize their vehicle to express personal affiliations, artistic creations, commercial advertising and general speech.

In view of the faceplate shown and described in FIG. 8 and the way the faceplate 112 may be attached to a counterweight 114 or 714, reference is again made to FIG. 2. Referring now to FIG. 2, in one embodiment, the faceplate 112 and the counterweight 714 may be constructed as a single unit which may be referred to as a weighted faceplate 111. The weighted faceplate may then be removably attached to a coupler assembly 119, which includes the adapter assembly 115 and the coupler 118. The coupler assembly may be pre-assembled as a single unit. In this embodiment, the coupler assembly 119 and the weighted faceplate 111 may be sold together or separately. In this way, a purchaser of four coupler assemblies 119 for an automobile may then purchase multiple weighted faceplates 111 for each of the wheels of the automobile. That is an automobile owner may purchase one or more weighted faceplates 111 per coupler assemblies 119.

In one embodiment, the counterweight 114, the adapter assembly 115, and the coupler 118 may be pre-assembled as a single unit which may be referred to a receiver assembly 113. In this embodiment, the adapter assembly 115 includes counterweight 714 and the faceplate includes only two holes 814. The faceplate 112 may then be removably attached to a receiver assembly 113. In this embodiment, the receiver assembly 113 and the faceplate 112 may be sold together or separately. In this way, a purchaser of four receiver assemblies 113 for an automobile may then purchase multiple faceplates 112 for each of the wheels of the automobile. That is, an automobile owner may purchase one or more faceplates 112 per receiver assembly 113.

Closing Comments

Throughout this description, the embodiments and examples shown should be considered as exemplars, rather than limitations on the apparatus and procedures disclosed or claimed. Although many of the examples presented herein involve specific combinations of system elements, it should be understood that those elements may be combined in other ways to accomplish the same objectives. Acts and features discussed only in connection with one embodiment are not intended to be excluded from a similar role in other embodiments, but may be.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A display apparatus for an automobile wheel comprising:
a faceplate removably coupled to a receiver assembly
the receiver assembly including a counterweight, a bearing device and a coupler
the coupler having a plurality of prongs on a first side and receivers for set screws adjacent to at least one of the prongs, such that when a set screw included with the coupler in the receiver is inserted into the receiver, at least one adjacent prong extends toward a hub of a rim of the automobile wheel to which the display apparatus is to be attached to assist in the attachment of the coupler to the rim
wherein the counterweight comprises a foot portion that is sufficiently heavy to keep the faceplate relatively stationary about an axis of rotation of the wheel when the automobile is in motion.

2. The display apparatus of claim 1 wherein the faceplate is removably coupled to the counterweight with a screw.

3. The display apparatus of claim 1 wherein the faceplate is removably coupled to the counterweight with a fastener.

4. The display apparatus of claim 1 wherein the counterweight is the shape of one of an umbrella or letter “T”.

5. The display apparatus of claim 1 wherein the prongs are generally perpendicular to a body portion of the coupler and the prongs have a contoured edge extending toward the hub and a lip to assist in the attachment of the coupler to the hub.

6. The display apparatus of claim 1 wherein the counterweight is weighted to keep a leg portion of the counterweight generally perpendicular to a direction the automobile is travelling while the automobile is in motion.

7. A display apparatus for an automobile wheel comprising:
a faceplate removably coupled to a counterweight
the counterweight coupled to an adapter assembly including an adapter, a bearing device, a bushing and a coupler
the coupler having a plurality of prongs to be pushed into a hub of a rim of the automobile wheel to which the display apparatus is to be attached, wherein the prongs are generally perpendicular to a body portion of the coupler and the prongs have a contoured edge extending toward the hub and a lip to assist in the attachment to the hub
wherein the counterweight comprises a foot portion that is sufficiently heavy to keep the faceplate relatively stationary about an axis of rotation of the wheel when the automobile is in motion.

8. The display apparatus of claim 7 wherein the coupler further comprises at least one receiver for a set screw adjacent to at least one of the prongs, such that when a set screw included with the coupler in the receiver is screwed further into the receiver, at least one adjacent prong is pushed to extend toward a hub of a rim of the automobile wheel to which the display apparatus is to be attached to assist in the attachment of the coupler to the rim.

9. The display apparatus of claim 7 wherein the faceplate is removably coupled to the counterweight with a screw.

10. The display apparatus of claim 7 wherein the faceplate is removably coupled to the counterweight with a fastener.

11. The display apparatus of claim 7 wherein the counterweight is the shape of one of an umbrella or letter “T”.

12. The display apparatus of claim 7 wherein the counterweight is weighted to keep a leg portion of the counterweight generally perpendicular to a direction the automobile is travelling while the automobile is in motion.

13. A display apparatus for an automobile wheel comprising:
a faceplate removably coupled to a counterweight
the counterweight coupled to an adapter assembly including an adapter, a bearing device, a bushing and a coupler
the coupler having a plurality of prongs on a first side and at least one receiver for a set screw adjacent to at least one of the prongs, such that when a set screw included with the coupler in the receiver is screwed further into the receiver, at least one adjacent prong is pushed to extend toward a hub of a rim of the automobile wheel to which to which the display apparatus is to be attached to assist in the attachment of the coupler to the rim
wherein the counterweight comprises a foot portion that is sufficiently heavy to keep the faceplate relatively stationary about an axis of rotation of the wheel when the automobile is in motion.

14. The display apparatus of claim 13 wherein the faceplate is removably coupled to the counterweight with a screw.

15. The display apparatus of claim 13 wherein the faceplate is removably coupled to the counterweight with a fastener.

16. The display apparatus of claim 13 wherein the counterweight is the shape of one of an umbrella or letter “T”.

17. The display apparatus of claim 13 wherein the prongs are generally perpendicular to a body portion of the coupler and the prongs have a contoured edge extending toward the hub and a lip to assist in the attachment of the coupler to the hub.

18. The display apparatus of claim 13 wherein the counterweight is weighted to keep a leg portion of the counterweight generally perpendicular to a direction the automobile is travelling while the automobile is in motion.
